(19) United States
(12) Patent Application Publication
(10) Pub. No.: US 2026/0369877 A1
(43) Pub. Date: Nov. 19, 2026

(54) Multi-port filtered antenna apparatus and antenna array

(71) Applicant: MEDIATEK INC., Hsinchu City (TW)

(72) Inventors: Nai-Chen Liu, Hsinchu City (TW); Yen-Ju Lin, Hsinchu City (TW); Hashem Zare Hoseini, Cambridge (GB)

(73) Assignee: MEDIATEK INC., Hsinchu City (TW)

(21) Appl. No.: 19/674,120

(22) Filed: May 11, 2026

Related U.S. Application Data
(60) Provisional application No. 63/804,719, filed on May 13, 2025.

(51) Int. Cl. H01Q 1/52; H01Q 9/04; H01Q 21/06

(52) U.S. Cl. CPC H01Q 1/525; H01Q 1/523; H01Q 9/0414; H01Q 21/065

(57) ABSTRACT

An antenna apparatus and an antenna array are disclosed. The antenna apparatus separates a transmit signal path from a receive signal path by using a first circuit coupled between a first port and the transmit signal path and a second circuit coupled between a second port and the receive signal path. The first circuit passes a first frequency band and provides out-of-band rejection in a second frequency band. The second circuit passes the second frequency band and provides out-of-band rejection in the first frequency band. The first port and the second port are spatially separated to provide port-to-port isolation. Transmit-receive isolation is established by the port-to-port isolation together with the two out-of-band rejections. The antenna array includes multiple antenna elements each having the antenna apparatus structure.

### CROSS REFERENCE TO RELATED APPLICATIONS

This application claims the benefit of U.S. Provisional Application No. 63/804,719, filed on May 13th, 2025. The content of the application is incorporated herein by reference.

### BACKGROUND

Wireless communication systems often employ frequency-division duplexing (FDD). In an FDD system, a transmit signal and a receive signal occupy different frequency bands. Both signals are conveyed through a shared antenna structure. Isolation between the transmit signal path and the receive signal path is therefore required. Without sufficient isolation, the transmit signal can leak into the receive signal path and degrade reception, since the transmit power is typically much higher than the receive power.

Conventional approaches rely on out-of-band rejection along each signal path to provide the required transmit-receive isolation. A higher isolation requirement demands greater out-of-band rejection. Greater out-of-band rejection tends to increase the in-band insertion loss along the signal path. This creates a trade-off between transmit-receive isolation and insertion loss. In the transmit path, increased insertion loss reduces effective isotropic radiated power (EIRP). In the receive path, increased insertion loss degrades noise FIGURE(NF) and gain-to-noise-temperature ratio (G/T). There is therefore a need for an antenna architecture that provides high transmit-receive isolation.

### SUMMARY

According to some embodiments, an antenna apparatus comprises a radiating element, N ports, a first circuit, and a second circuit. The radiating element is configured to radiate and receive electromagnetic signals. The N ports are coupled to the radiating element. N is an integer greater than or equal to 2. The first circuit comprises a first filter coupled between a first port of the N ports and a transmit signal path, and is configured to pass signals in a first frequency band and to provide a first out-of-band rejection in a second frequency band. The second circuit comprises a second filter coupled between a second port of the N ports and a receive signal path, and is configured to pass signals in the second frequency band and to provide a second out-of-band rejection in the first frequency band. The first frequency band and the second frequency band are non-overlapping, and the first port and the second port are spatially separated to provide a port-to-port isolation therebetween.

According to other embodiments, an antenna array comprises a plurality of antenna elements. Each antenna element comprises a radiating element, a plurality of ports, a first circuit, and a second circuit. The radiating element is configured to radiate and receive electromagnetic signals. The plurality of ports are coupled to the radiating element. The first circuit comprises a first filter coupled between a first port of the plurality of ports and a transmit signal path, and is configured to pass signals in a first frequency band and to provide a first out-of-band rejection in a second frequency band. The second circuit comprises a second filter coupled between a second port of the plurality of ports and a receive signal path, and is configured to pass signals in the second frequency band and to provide a second out-of-band rejection in the first frequency band. The first frequency band and the second frequency band are non-overlapping, and the first port and the second port of each antenna element are spatially separated to provide a port-to-port isolation therebetween. The plurality of antenna elements are arranged in at least two distinct orientations differing from one another by a rotation angle about an axis normal to a plane of the antenna array. A combined far-field radiation pattern of the antenna array exhibits circular polarization over a predetermined frequency band.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an antenna apparatus according to one embodiment of the present disclosure.

FIG. 2 is a schematic diagram of an antenna apparatus according to another embodiment of the present disclosure.

FIG. 3 is a schematic diagram of an antenna apparatus according to another embodiment of the present disclosure.

FIG. 4 is a schematic diagram of an antenna array according to one embodiment of the present disclosure.

FIG. 5 is a top view of the antenna array illustrated in FIG. 4.

FIG. 6 is a schematic diagram of an antenna array according to another embodiment of the present disclosure.

FIG. 7 is a top view of the antenna array illustrated in FIG. 6.

FIG. 8 is a top view of an antenna array according to another embodiment of the present disclosure.

FIG. 9 is a top view of an antenna array according to another embodiment of the present disclosure.

FIG. 10 is a top view of an antenna array according to another embodiment of the present disclosure.

FIG. 11 is a top view of an antenna array according to another embodiment of the present disclosure.

### DETAILED DESCRIPTION

The following description sets forth example embodiments and does not limit the scope of the appended claims. Features described in connection with one embodiment may be combined with features of other embodiments unless the context clearly indicates otherwise. Reference throughout this specification to "one embodiment," "an embodiment," "certain embodiments," or similar language means that a particular feature, structure, or characteristic described in connection with the embodiment may be included in at least one embodiment.

As used herein, the terms "first," "second," "third," and similar ordinal terms are used to distinguish different instances of similar components. These terms do not require a particular order, position, priority, or sequence unless the context clearly indicates otherwise.

As used herein, the term "coupled" refers to any connection, coupling, link, or similar relationship by which signals carried by one system element are imparted to another system element. Coupled elements may be directly connected to one another or may be separated by intermediate components that manipulate or modify signals.

As used herein, the term "comprising" or "comprises" is open-ended and does not exclude additional, unrecited elements or method steps. The terms "a" and "an" refer to one or more unless context clearly indicates otherwise.

As used herein, a component "configured to" perform a function refers to an existing physical structure arranged to perform the function. The physical structure may include circuitry, conductive structures, electromagnetic structures, or combinations thereof.

In the figures, identical reference numerals identify components of the same structural type. The figures do not include first or second designators on individual instances of such components. Particular instances may be identified by their position in a figure or by another component to which they are coupled. For example, this description may refer to a duplexer 42 included in a circuit 40 associated with the terminal TX or to a port 30 associated with the terminal RX. Such positional or relational identifiers are used for clarity and do not change the component names represented by the reference numerals.

As used herein, a component may be described as "associated with" a terminal when the component is coupled along, assigned to, or used with a signal path connected to that terminal. For example, a circuit 40 associated with the terminal TX refers to a circuit 40 used in a signal path 50 coupled to the terminal TX. A circuit 40 associated with the terminal RX refers to a circuit 40 used in a signal path 50 coupled to the terminal RX. This relational language is used to identify particular instances of components having the same reference numeral.

As used herein, the term "circular polarization" refers to a polarization state in which an electric field vector of a radiated electromagnetic wave, observed at a fixed point in space, traces a substantially circular locus as a function of time. Circular polarization may be produced by a combined far-field radiation pattern of an antenna array having rotationally arranged antenna elements fed with corresponding signal phases.

As used herein, the term "magneto-electric dipole antenna" refers to an antenna structure that uses electric dipole radiation and magnetic dipole radiation to form a radiating structure. The term may include antenna structures arranged to provide broadside radiation from combined electric and magnetic current distributions.

As used herein, the term "out-of-band rejection" refers to attenuation or blocking of signals outside a pass-band of a filter or circuit. For a circuit associated with a transmit signal path, out-of-band rejection may reject a receive band. For a circuit associated with a receive signal path, out-of-band rejection may reject a transmit band.

As used herein, the term "port-to-port isolation" refers to electromagnetic or electrical isolation between different ports of an antenna structure. Port-to-port isolation may arise from spatial separation, polarization separation, frequency separation, or a combination of such structural relationships.

As used herein, the term "receive signal path" refers to a conductive or electromagnetic path that carries a receive signal from an antenna port toward receive circuitry. The receive signal path may be frequency selected by a filter 44 or by another circuit element.

As used herein, the term "rotational orientation" refers to an angular orientation of an antenna element or a group of antenna elements about an axis normal to a plane of an antenna array. Different rotational orientations may differ by a rotation angle.

As used herein, the term "stacked patch antenna" refers to an antenna having multiple patch structures arranged in a stacked relationship. The patch structures may be electromagnetically coupled or directly fed according to the selected antenna implementation.

As used herein, the term "sub-array tile" refers to a group of adjacent antenna elements that is treated as a unit for array placement or rotation. A sub-array tile may include two or more adjacent antenna elements.

As used herein, the term "termination load" refers to a load coupled to a signal path to absorb received energy, reduce reflected energy, or both. A termination load may reduce reflected energy that would otherwise return along the signal path.

As used herein, the term "transmit signal path" refers to a conductive or electromagnetic path that carries a transmit signal from transmit circuitry toward an antenna port. The transmit signal path may be frequency selected by a filter 44 or by another circuit element.

As used herein, the term "transmit-receive isolation" refers to isolation between a transmit signal path and a receive signal path. Transmit-receive isolation may be established by port-to-port isolation, out-of-band rejection in the respective signal paths, or both.

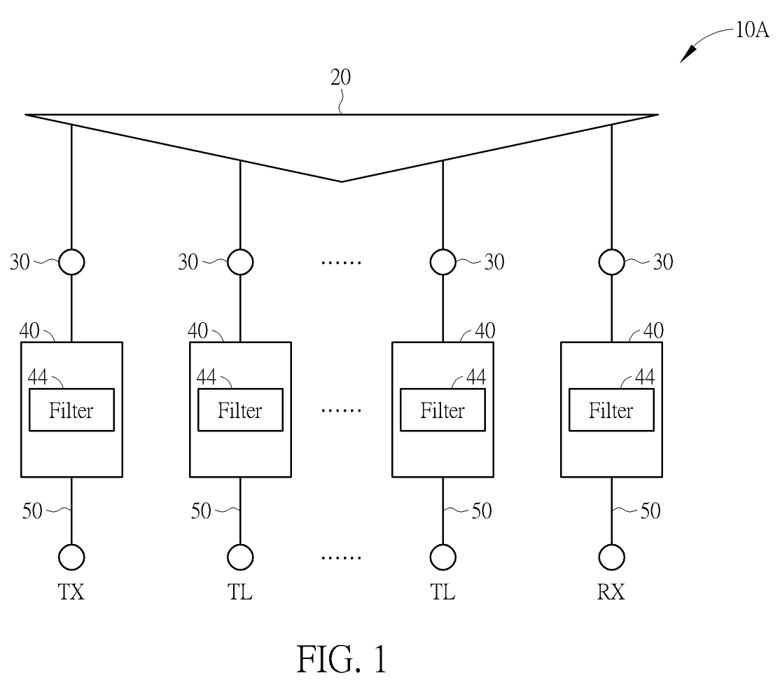

FIG. 1 illustrates antenna apparatus 10A according to a multi-port embodiment. In the embodiment illustrated in FIG. 1, the antenna apparatus 10A includes a radiating element 20, N ports 30, N circuits 40, N signal paths 50, and N terminals, where N is an integer greater than or equal to 4. Each port 30 is coupled to the radiating element 20, and each circuit 40 includes a filter 44. The value of N described with reference to FIG. 1 is specific to the illustrated multi-port embodiment and does not limit other antenna apparatus embodiments described herein. In other embodiments, N may be an integer greater than or equal to 2.

Each signal path 50 is coupled between a corresponding circuit 40 and a corresponding terminal. The signal paths 50 are independent conductive or electromagnetic paths and are not part of the circuits 40. In the illustrated embodiment, each circuit 40 is coupled between a corresponding port 30 and a corresponding signal path 50. The radiating element 20 is configured to radiate and receive electromagnetic signals through the ports 30.

The N terminals include at least one terminal TX, at least one terminal RX, and at least one terminal TL. FIG. 1 depicts a representative four-terminal arrangement that includes one terminal TX, two terminals TL, and one terminal RX. The ellipses between the depicted ports 30, circuits 40, and signal paths 50 indicate that antenna apparatus 10A may include additional ports 30, additional circuits 40, additional signal paths 50, and additional terminals. Accordingly, the number of terminals assigned as terminal TX, the number of terminals assigned as terminal RX, and the number of terminals assigned as terminal TL may each be one or more.

The terminal TX, the terminal TL, and the terminal RX serve different functional roles depending on the signal path 50 to which each terminal is coupled. A signal path 50 coupled to a terminal TX may serve as a transmit signal path. Each terminal TX is configured to receive a transmit signal from transmit circuitry and to direct the transmit signal toward the radiating element 20 through the transmit signal path, the filter 44 included in the corresponding circuit 40, and the corresponding port 30. The transmit circuitry may include, for example, a power amplifier, a transmitter, an up-converter, a mixer, a radio-frequency front-end circuit, a transceiver circuit, or another circuit configured to generate, amplify, frequency-convert, or otherwise provide the transmit signal.

A signal path 50 coupled to a terminal RX may serve as a receive signal path. Each terminal RX is configured to output a receive signal from the radiating element 20 to receive circuitry through the corresponding port 30, the filter 44 included in the corresponding circuit 40, and the receive signal path. The receive circuitry may include, for example, a low-noise amplifier, a receiver, a down-converter, a mixer, a radio-frequency front-end circuit, a transceiver circuit, or another circuit configured to amplify, frequency-convert, demodulate, or otherwise process the receive signal. The transmit circuitry and the receive circuitry may be located outside the antenna apparatus 10A and are separate from the circuits 40 unless expressly described otherwise.

In some embodiments, the filter 44 associated with the terminal TX is configured to pass signals in a transmit band and to reject signals in a receive band. In some embodiments, the filter 44 associated with the terminal RX is configured to pass signals in the receive band and to reject signals in the transmit band. The transmit band and the receive band may be non-overlapping frequency bands. Accordingly, the circuit 40 associated with the terminal TX and the circuit 40 associated with the terminal RX may provide different frequency-selection characteristics for different signal paths 50.

Each terminal TL is configured to be coupled to a termination load. The terminal TL may be associated with a port 30 that is different from a port 30 associated with the terminal TX and different from a port 30 associated with the terminal RX. The termination load may be connected to the associated port 30 through the terminal TL, the corresponding signal path 50, and the corresponding circuit 40.

In some embodiments, the termination load is configured to absorb energy received at the associated port 30. In some embodiments, the termination load is configured to prevent reflected energy from returning to the corresponding circuit 40 or to another circuit 40 of the antenna apparatus 10A. In some embodiments, the termination load is configured both to absorb energy received at the associated port 30 and to prevent reflected energy from returning to the corresponding circuit 40 or to another circuit 40 of the antenna apparatus 10A.

In the embodiment of FIG. 1, different ports 30 are coupled to respective portions of the radiating element 20. The ports 30, the respective portions of the radiating element 20 to which the ports 30 are coupled, or both may be spatially separated from one another. The spatial separation may provide port-to-port isolation between the port 30 associated with the terminal TX and the port 30 associated with the terminal RX. The port-to-port isolation, the rejection of receive-band energy by the filter 44 associated with the terminal TX, and the rejection of transmit-band energy by the filter 44 associated with the terminal RX may together establish or improve transmit-receive isolation between the transmit signal path and the receive signal path.

The antenna apparatus 10A therefore provides a multi-port structure in which transmit, receive, and termination functions may be assigned to different terminals. In the multi-port structure, spatial separation between selected ports 30 and frequency selection by the corresponding filters 44 may be used together to improve isolation between a transmit signal path and a receive signal path.

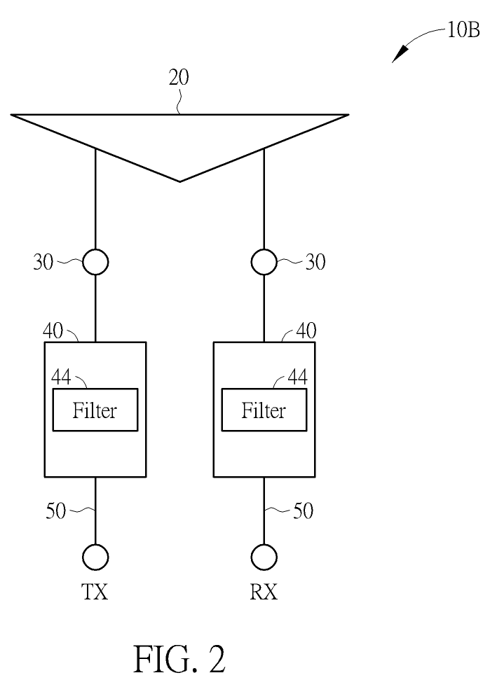

FIG. 2 shows antenna apparatus 10B according to another embodiment of the present disclosure. The antenna apparatus 10B includes the radiating element 20, two ports 30, two circuits 40, two signal paths 50, the terminal TX, and the terminal RX. Each port 30 is coupled to the radiating element 20, and each circuit 40 includes a filter 44. The antenna apparatus 10B is an embodiment in which N is equal to 2.

The signal path 50 coupled to the terminal TX serves as a transmit signal path. The circuit 40 associated with the terminal TX is coupled between the transmit signal path and a port 30 associated with the terminal TX. The filter 44 included in the circuit 40 associated with the terminal TX is configured to pass signals in a transmit band and to reject signals in a receive band.

The signal path 50 coupled to the terminal RX serves as a receive signal path. The circuit 40 associated with the terminal RX is coupled between the receive signal path and a port 30 associated with the terminal RX. The filter 44 included in the circuit 40 associated with the terminal RX is configured to pass signals in the receive band and to reject signals in the transmit band. The transmit band and the receive band may be non-overlapping frequency bands. Accordingly, the circuit 40 associated with the terminal TX and the circuit 40 associated with the terminal RX provide different frequency-selection characteristics for the transmit signal path and the receive signal path.

In antenna apparatus 10B, the circuit 40 associated with the terminal TX may be identified as a first circuit. The filter 44 included in the circuit 40 associated with the terminal TX may be identified as a first filter. The port 30 coupled to the circuit 40 associated with the terminal TX may be identified as a first port.

The circuit 40 associated with the terminal RX may be identified as a second circuit. The filter 44 included in the circuit 40 associated with the terminal RX may be identified as a second filter. The port 30 coupled to the circuit 40 associated with the terminal RX may be identified as a second port.

The port 30 associated with the terminal TX and the port 30 associated with the terminal RX may be coupled to respective portions of the radiating element 20. The ports 30, the respective portions of the radiating element 20 to which the ports 30 are coupled, or both may be spatially separated from one another. The spatial separation may provide port-to-port isolation between the transmit signal path and the receive signal path.

The port-to-port isolation may work together with the frequency selection provided by the filters 44. The filter 44 included in the circuit 40 associated with the terminal TX may reject receive-band energy. The filter 44 included in the circuit 40 associated with the terminal RX may reject transmit-band energy. The port-to-port isolation and the rejection provided by the two filters 44 may together establish or improve transmit-receive isolation between the transmit signal path and the receive signal path.

The antenna apparatus 10B therefore provides a two-port arrangement in which a transmit signal path and a receive signal path are coupled to the radiating element 20 through different ports 30 and through filters 44 having different frequency-selection characteristics.

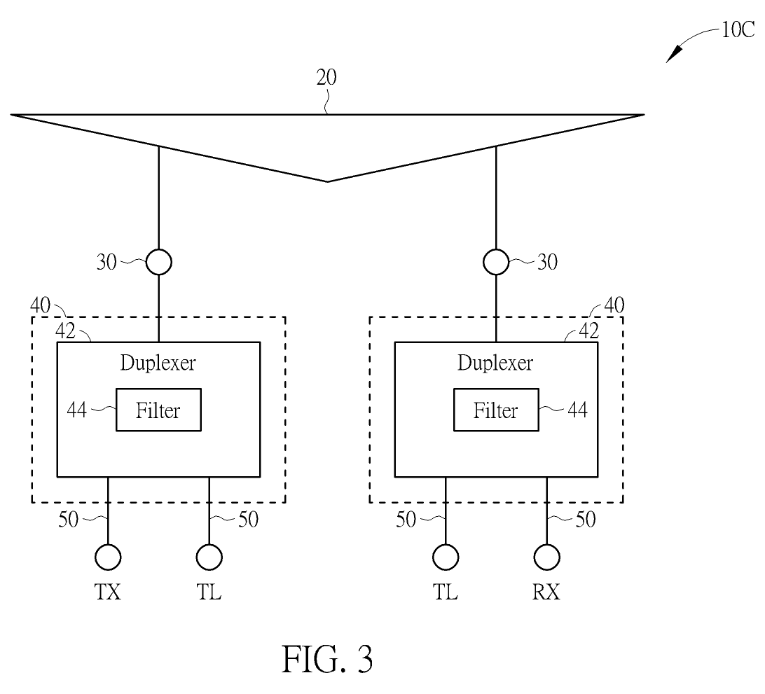

FIG. 3 depicts antenna apparatus 10C according to another embodiment of the present disclosure. The antenna apparatus 10C is a duplexer-based embodiment. The antenna apparatus 10C includes the radiating element 20, two ports 30, two circuits 40, four signal paths 50, the terminal TX, two terminals TL, and the terminal RX. Each port 30 is coupled to the radiating element 20. Each circuit 40 includes a duplexer 42, and each duplexer 42 includes a filter 44. In other embodiments, each circuit 40 may include two or more filters 44.

Compared with the antenna apparatus 10B of FIG. 2, the antenna apparatus 10C uses the duplexers 42 to provide the filtering functions of the circuits 40 and to provide additional paths to the terminals TL.

Each duplexer 42 includes a first terminal, a second terminal, and a third terminal. The first terminal, the second terminal, and the third terminal of a duplexer 42 are connection terminals of the duplexer 42 and are different from the terminals TX, RX, and TL unless the context expressly indicates otherwise. In the circuit 40 associated with the terminal TX, the first terminal of the duplexer 42 is coupled to the port 30 associated with the terminal TX, the second terminal of the duplexer 42 is coupled to the terminal TX through the signal path 50 coupled to the terminal TX, and the third terminal of the duplexer 42 is coupled to one terminal TL through a corresponding signal path 50. The terminal TL coupled to the third terminal of the duplexer 42 in the circuit 40 associated with the terminal TX may be coupled to a first termination load.

In the circuit 40 associated with the terminal RX, the first terminal of the duplexer 42 is coupled to the port 30 associated with the terminal RX, the second terminal of the duplexer 42 is coupled to the terminal RX through the signal path 50 coupled to the terminal RX, and the third terminal of the duplexer 42 is coupled to another terminal TL through a corresponding signal path 50. The terminal TL coupled to the third terminal of the duplexer 42 in the circuit 40 associated with the terminal RX may be coupled to a second termination load.

The signal path 50 coupled to the terminal TX serves as a transmit signal path, and the signal path 50 coupled to the terminal RX serves as a receive signal path. The duplexer 42 included in the circuit 40 associated with the terminal TX may pass signals in a transmit band and reject signals in a receive band. The duplexer 42 included in the circuit 40 associated with the terminal RX may pass signals in the receive band and reject signals in the transmit band. The transmit band and the receive band may be non-overlapping frequency bands.

The ports 30 associated with the terminal TX and the terminal RX may be spatially separated as described above. Accordingly, the port-to-port isolation between those ports 30 may work together with the frequency selection provided by the duplexers 42 to establish or improve transmit-receive isolation between the transmit signal path and the receive signal path.

Each terminal TL is configured to be coupled to a termination load. In some embodiments, a termination load coupled to a terminal TL absorbs energy delivered to that terminal TL through the corresponding signal path 50. In some embodiments, a termination load coupled to a terminal TL prevents reflected energy from returning from that terminal TL toward the duplexer 42 in the corresponding circuit 40 or toward another circuit 40 of the antenna apparatus 10C. In some embodiments, a termination load coupled to a terminal TL both absorbs energy delivered to that terminal TL and prevents reflected energy from returning from that terminal TL toward the duplexer 42 in the corresponding circuit 40 or toward another circuit 40 of the antenna apparatus 10C.

The antenna apparatus 10C therefore provides a duplexer-based arrangement in which the circuits 40 include duplexers 42, the duplexers 42 provide filtering for the transmit and receive signal paths, and the third terminals of the duplexers 42 are coupled to termination paths.

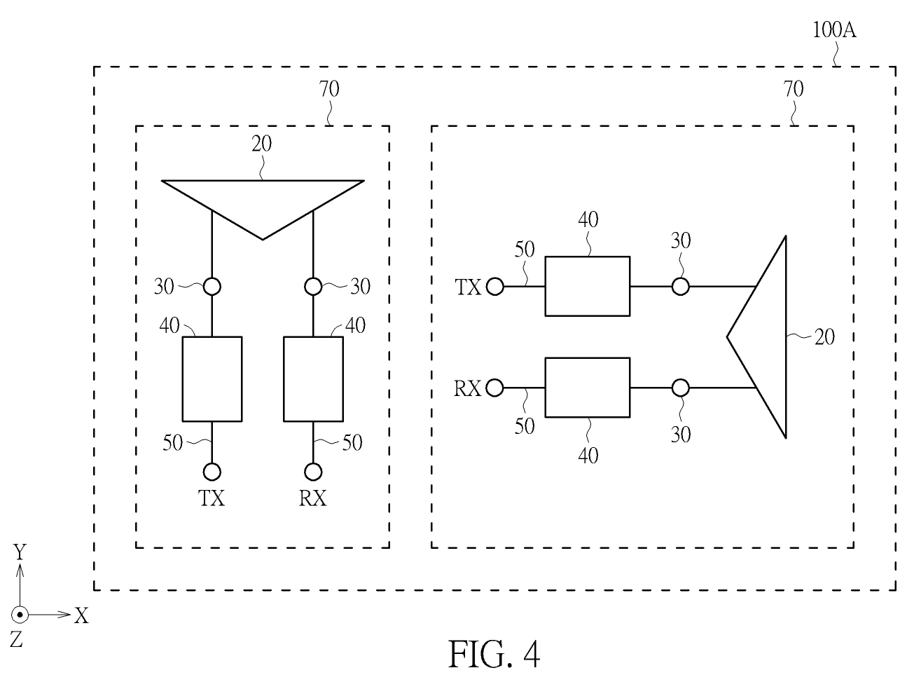

FIGS. 4-11 illustrate antenna array embodiments. The antenna array embodiments described below may use any of the antenna apparatus configurations described above with reference to FIGS. 1, 2, and 3.

In FIGS. 4-11, axis X and axis Y define a reference plane substantially parallel to a plane of the antenna array. Axis Z is normal to that plane. Where a circle-dot symbol is shown, axis Z is directed out of the plane of the figure. Unless otherwise indicated, a reference to an axis normal to a plane of an antenna array refers to axis Z.

An antenna element 70 refers to an individual radiating unit of an antenna array. Each antenna element 70 may include any of the antenna apparatus configurations described above. Accordingly, an antenna element 70 may include, as applicable, the radiating element 20, the ports 30, the circuits 40, the duplexer 42, the filter 44, the signal paths 50, and one or more of the terminals TX, TL, and RX.

In the array embodiments described below, different antenna elements 70 or different groups of antenna elements 70 may have different rotational orientations about axis Z. A rotation angle may be equal to 360 degrees divided by M, where M is an integer greater than or equal to 2. For example, when M is equal to 4, the rotation angle is 90 degrees. When M is equal to 2, the rotation angle is 180 degrees.

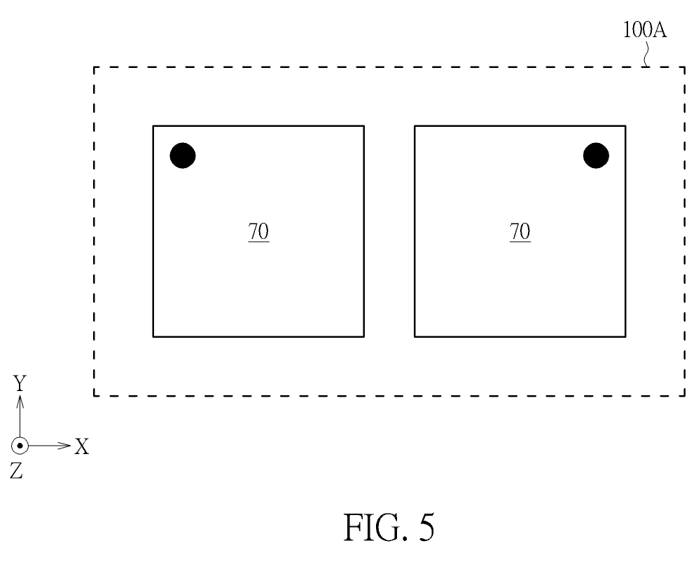

FIG. 4 is a schematic diagram of antenna array 100A according to an embodiment of the present disclosure, and FIG. 5 is a top view of the antenna array 100A illustrated in FIG. 4. The antenna array 100A includes two antenna elements 70 arranged in a row. Each antenna element 70 may be implemented in accordance with the antenna apparatus 10B described above with reference to FIG. 2. In the illustrated embodiment, each antenna element 70 includes the radiating element 20, two ports 30, two circuits 40, two signal paths 50, the terminal TX, and the terminal RX.

In the embodiment of FIGS. 4 and 5, the two antenna elements 70 have different rotational orientations about axis Z. The antenna element 70 on the left side has a first rotational orientation, and the antenna element 70 on the right side has a second rotational orientation. The second rotational orientation is rotated by 90 degrees about axis Z relative to the first rotational orientation. This arrangement is an example in which M is equal to 4 and the rotation angle is 90 degrees.

Because the two antenna elements 70 have different rotational orientations, corresponding internal structures of the two antenna elements 70 also have different orientations. For example, the radiating element 20, the ports 30, the circuits 40, and the signal paths 50 of the antenna element 70 on the right side may be rotated by 90 degrees relative to corresponding structures of the antenna element 70 on the left side.

In FIG. 5 and the later top views, a black dot within an antenna element 70 indicates a reference orientation marker of the antenna element 70. The reference orientation marker is a schematic marker used to show the rotational orientation of the antenna element 70 as a whole about axis Z. The black dot need not represent a physical port, a feed point, or another physical component of the antenna element 70. Antenna elements 70 having black dots at the same relative position have the same rotational orientation. Antenna elements 70 having black dots at different relative positions have different rotational orientations.

In FIG. 5, each antenna element 70 is depicted as a rectangular outline. The antenna element 70 on the left side has its black dot near an upper-left corner, and the antenna element 70 on the right side has its black dot near an upper-right corner. These different black-dot positions indicate the first rotational orientation and the second rotational orientation described with reference to FIG. 4.

The first rotational orientation and the second rotational orientation are arranged along the row in an alternating manner. In some embodiments, this rotational arrangement contributes to a combined far-field radiation pattern of the antenna array 100A that exhibits circular polarization over a predetermined frequency band.

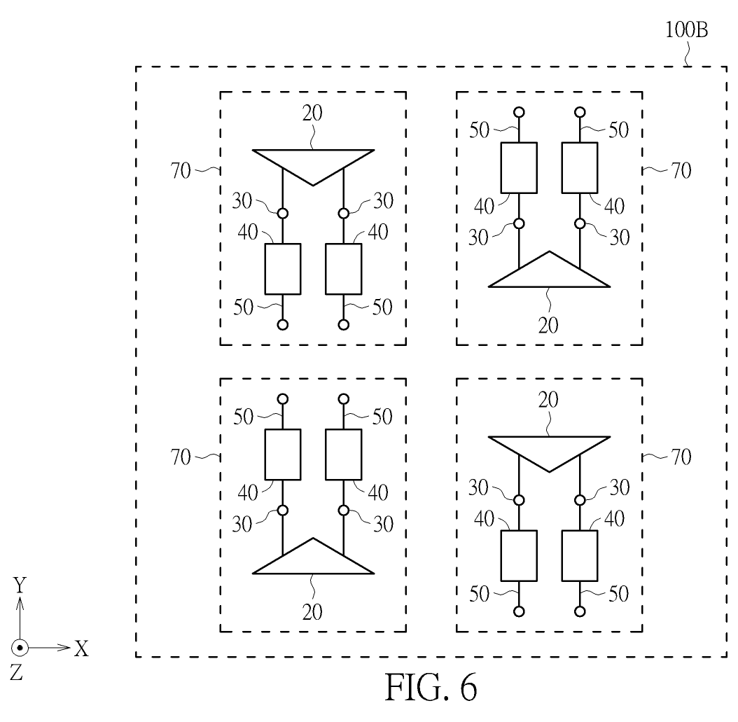

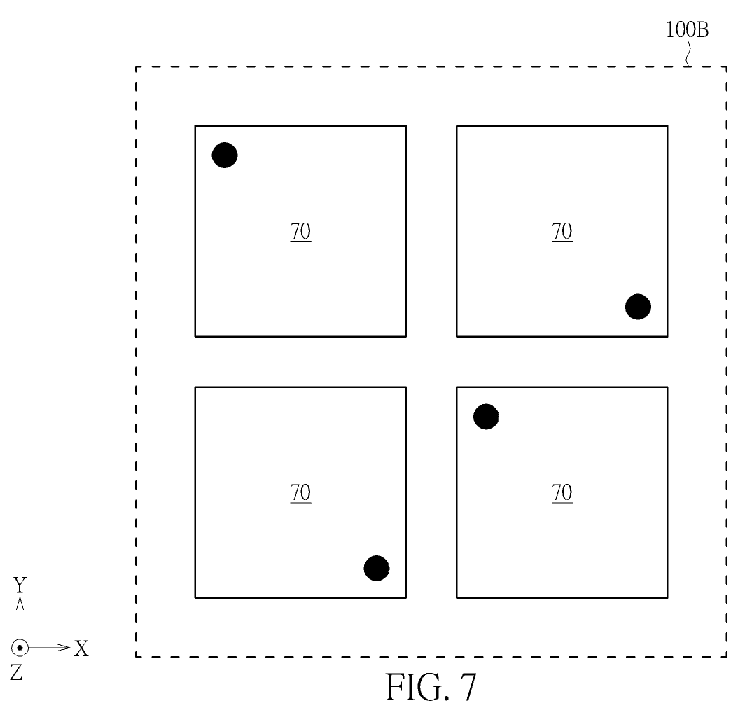

FIG. 6 illustrates antenna array 100B according to another embodiment of the present disclosure, and FIG. 7 shows a top view of the antenna array 100B illustrated in FIG. 6. The antenna array 100B includes four antenna elements 70 arranged in a 2x2 array. Each antenna element 70 may be implemented in accordance with any of the antenna apparatus configurations described above with reference to FIGS. 1, 2, and 3. In the schematic view of FIG. 6, the internal structures of the antenna elements 70 are shown in their respective rotational orientations.

In the embodiment of FIGS. 6 and 7, the antenna elements 70 in the upper-left and lower-right positions have a first rotational orientation. The antenna elements 70 in the upper-right and lower-left positions have a second rotational orientation. The second rotational orientation is rotated by 180 degrees about axis Z relative to the first rotational orientation. This arrangement is an example in which M is equal to 2 and the rotation angle is 180 degrees.

FIG. 7 uses black dots to show the same rotational-orientation arrangement in top view. The black dots of the antenna elements 70 in the upper-left and lower-right positions are located at the same relative position, indicating the first rotational orientation. The black dots of the antenna elements 70 in the upper-right and lower-left positions are located at another same relative position, indicating the second rotational orientation.

As a result, two antenna elements 70 that are adjacent in a row direction or in a column direction have rotational orientations that differ by 180 degrees. This arrangement provides rotational diversity across the antenna array 100B while using two rotational orientations. In some embodiments, this rotational arrangement contributes to a combined far-field radiation pattern of the antenna array 100B that exhibits circular polarization over a predetermined frequency band.

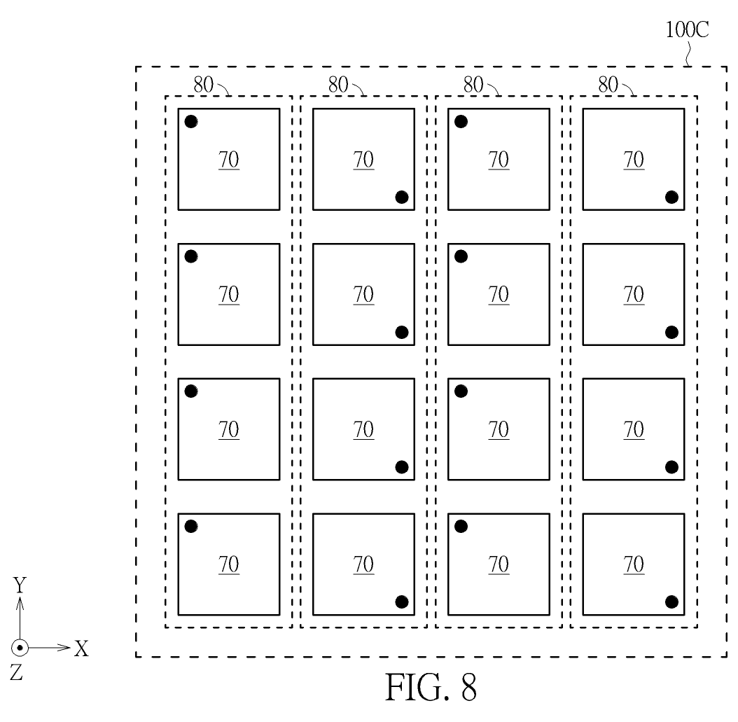

For FIGS. 8-11, a sub-array tile 80 refers to a group of two or more adjacent antenna elements 70 that are considered together for describing placement or rotational orientation in an antenna array. A sub-array tile 80 may include, for example, antenna elements 70 arranged in a column, in a row, in a 2x2 group, or in another adjacent group. The term sub-array tile 80 does not require the group to be formed as a separate package or a separately manufactured module, unless expressly described otherwise.

A sub-array tile 80 may be rotated as a unit. When a sub-array tile 80 is rotated as a unit, the antenna elements 70 inside the sub-array tile 80 keep their relative positions and their relative rotational orientations with respect to one another, while the sub-array tile 80 as a whole has a different rotational orientation from another sub-array tile 80. For example, a first sub-array tile 80 and an adjacent second sub-array tile 80 may contain the same internal arrangement of antenna elements 70, but the second sub-array tile 80 may be rotated by a rotation angle about axis Z relative to the first sub-array tile 80.

In some embodiments, different rotational orientations are provided at the level of the sub-array tiles 80. For example, all antenna elements 70 within one sub-array tile 80 may share a common rotational orientation, while an adjacent sub-array tile 80 may be rotated as a unit. In other embodiments, different rotational orientations are provided by arranging individual antenna elements 70 within the same sub-array tile 80 in different rotational orientations. In still other embodiments, both arrangements may be used in the same antenna array.

FIG. 8 depicts antenna array 100C according to another embodiment of the present disclosure. The antenna array 100C includes sixteen antenna elements 70 arranged in a 4x4 array and four sub-array tiles 80. Each sub-array tile 80 includes a 1x4 column of four antenna elements 70. Each antenna element 70 may be implemented in accordance with any of the antenna apparatus configurations described above with reference to FIGS. 1, 2, and 3.

In FIG. 8, rotational diversity is provided at the level of the sub-array tiles 80. Within each sub-array tile 80, the four antenna elements 70 share a common rotational orientation. In the illustrated embodiment, the antenna elements 70 in the first and third columns have black dots near upper-left corners, indicating a first rotational orientation. The antenna elements 70 in the second and fourth columns have black dots near lower-right corners, indicating a second rotational orientation.

The second rotational orientation differs from the first rotational orientation by 180 degrees about axis Z. Thus, the sub-array tiles 80 in the second and fourth columns are rotated as units by 180 degrees relative to the sub-array tiles 80 in the first and third columns. This arrangement is an example in which M is equal to 2 and the rotation angle is 180 degrees.

Accordingly, antenna array 100C provides different rotational orientations by rotating selected sub-array tiles 80 as units, while the antenna elements 70 within each sub-array tile 80 maintain a common rotational orientation. In some embodiments, this arrangement contributes to a combined far-field radiation pattern of the antenna array 100C that exhibits circular polarization over a predetermined frequency band.

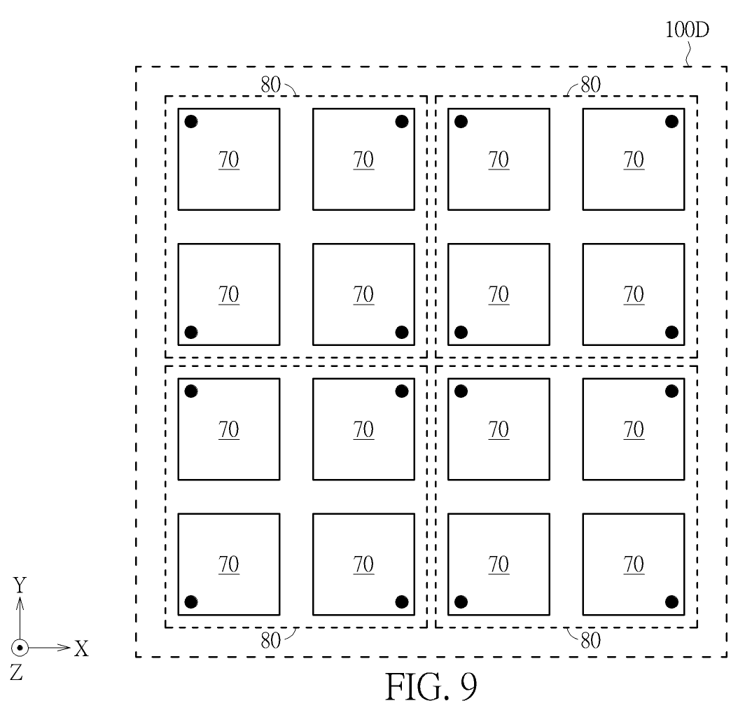

FIG. 9 illustrates antenna array 100D according to another embodiment of the present disclosure. The antenna array 100D includes sixteen antenna elements 70 arranged in a 4x4 array and four sub-array tiles 80. Each sub-array tile 80 includes a 2x2 group of four antenna elements 70. Each antenna element 70 may be implemented in accordance with any of the antenna apparatus configurations described above with reference to FIGS. 1, 2, and 3.

In FIG. 9, the four sub-array tiles 80 have the same tile orientation. The sub-array tiles 80 are therefore not rotated as units relative to one another. Instead, different rotational orientations are provided within each sub-array tile 80 by the individual antenna elements 70.

Within each sub-array tile 80, the four antenna elements 70 have four distinct rotational orientations. The antenna element 70 in the upper-left position has a black dot near an upper-left corner. The antenna element 70 in the upper-right position has a black dot near an upper-right corner. The antenna element 70 in the lower-left position has a black dot near a lower-left corner. The antenna element 70 in the lower-right position has a black dot near a lower-right corner. These black-dot positions indicate that the four antenna elements 70 within the same sub-array tile 80 have different rotational orientations.

The four rotational orientations within each sub-array tile 80 are uniformly spaced by the rotation angle about axis Z. In the illustrated embodiment, the rotation angle is 90 degrees. Accordingly, each sub-array tile 80 includes antenna elements 70 arranged in four rotational orientations spaced by 90 degrees. In some embodiments, at least one antenna element 70 in each sub-array tile 80 has a rotational orientation that differs from an adjacent antenna element 70 by the rotation angle.

Thus, antenna array 100D provides rotational diversity by arranging individual antenna elements 70 in different rotational orientations within each sub-array tile 80. In some embodiments, this arrangement contributes to a combined far-field radiation pattern of the antenna array 100D that exhibits circular polarization over a predetermined frequency band.

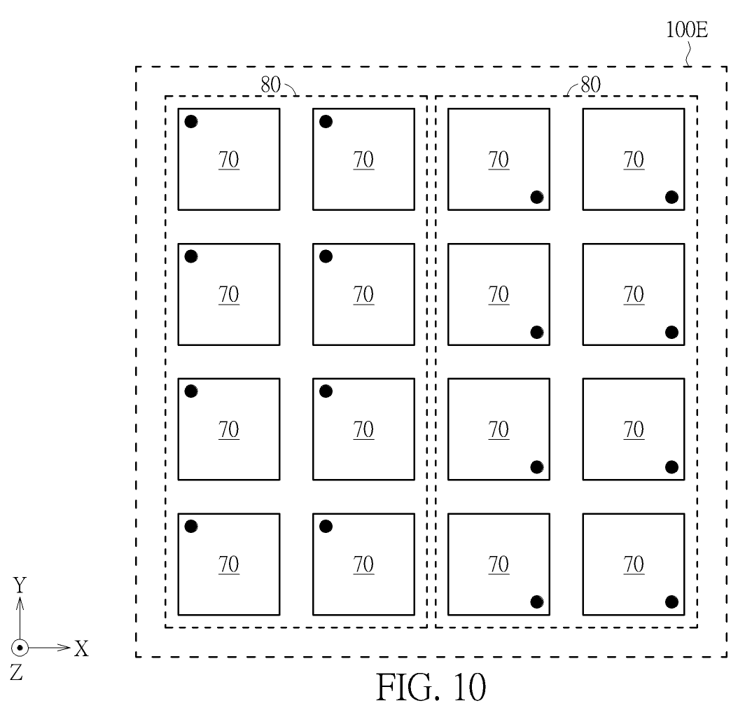

FIG. 10 provides a top view of antenna array 100E according to another embodiment of the present disclosure. The antenna array 100E includes sixteen antenna elements 70 arranged in a 4x4 array and two sub-array tiles 80. Each sub-array tile 80 includes eight antenna elements 70 arranged in two columns and four rows. Each antenna element 70 may be implemented in accordance with any of the antenna apparatus configurations described above with reference to FIGS. 1, 2, and 3.

In FIG. 10, rotational diversity is provided at the level of the sub-array tiles 80. Within each sub-array tile 80, the antenna elements 70 share a common rotational orientation. In the illustrated embodiment, the antenna elements 70 in the sub-array tile 80 on the left side of FIG. 10 have black dots near upper-left corners, indicating a first rotational orientation. The antenna elements 70 in the sub-array tile 80 on the right side of FIG. 10 have black dots near low-right corners, indicating a second rotational orientation.

The second rotational orientation differs from the first rotational orientation by 180 degrees about axis Z. Thus, the sub-array tile 80 on the right side of FIG. 10 is rotated as a unit by 180 degrees relative to the sub-array tile 80 on the left side of FIG. 10. This arrangement is an example in which M is equal to 2 and the rotation angle is 180 degrees.

Accordingly, antenna array 100E provides different rotational orientations by rotating the sub-array tiles 80 as units, while the antenna elements 70 within each sub-array tile 80 maintain a common rotational orientation. In some embodiments, this arrangement contributes to a combined far-field radiation pattern of the antenna array 100E that exhibits circular polarization over a predetermined frequency band.

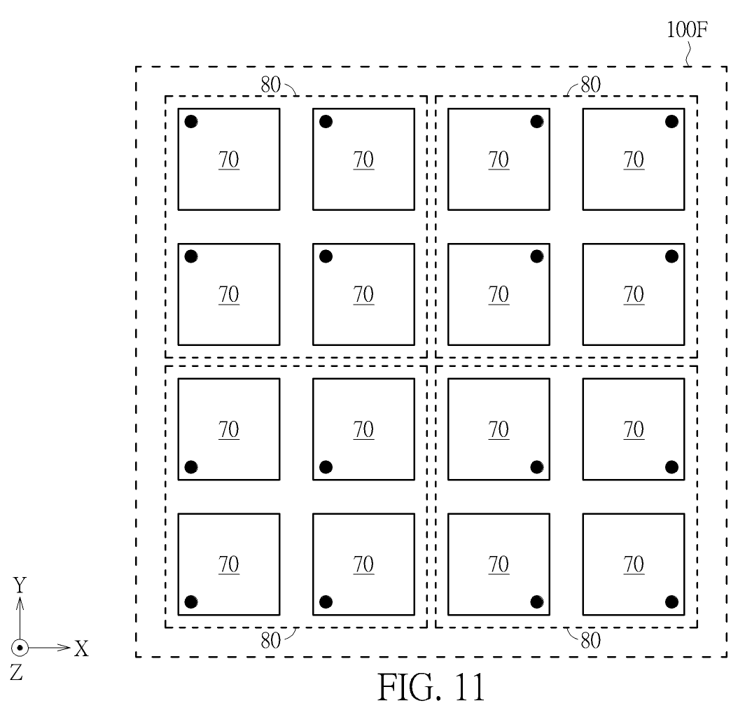

FIG. 11 depicts antenna array 100F according to another embodiment of the present disclosure. The antenna array 100F includes sixteen antenna elements 70 arranged in a 4x4 array and four sub-array tiles 80. Each sub-array tile 80 includes a 2x2 arrangement of antenna elements 70. Each antenna element 70 may be implemented in accordance with any of the antenna apparatus configurations described above with reference to FIGS. 1, 2, and 3.

In FIG. 11, rotational diversity is provided at the level of the sub-array tiles 80. Within each sub-array tile 80, the antenna elements 70 share a common rotational orientation. However, the four sub-array tiles 80 have different rotational orientations from one another.

The black dots in FIG. 11 indicate these four rotational orientations. The antenna elements 70 in the sub-array tile 80 in the upper-left position have black dots near upper-left corners. The antenna elements 70 in the sub-array tile 80 in the upper-right position have black dots near upper-right corners. The antenna elements 70 in the sub-array tile 80 in the lower-left position have black dots near lower-left corners. The antenna elements 70 in the sub-array tile 80 in the lower-right position have black dots near lower-right corners. These black-dot positions indicate that the four sub-array tiles 80 have four distinct rotational orientations.

The four rotational orientations are uniformly spaced by the rotation angle about axis Z. In the illustrated embodiment, the rotation angle is 90 degrees. Accordingly, the four sub-array tiles 80 provide four distinct rotational orientations spaced by 90 degrees, and each sub-array tile 80 is rotated as a unit with respect to at least one adjacent sub-array tile 80.

Thus, antenna array 100F provides rotational diversity by rotating the sub-array tiles 80 as units and by arranging the four sub-array tiles 80 in four distinct rotational orientations. In some embodiments, this arrangement contributes to a combined far-field radiation pattern of the antenna array 100F that exhibits circular polarization over a predetermined frequency band.

In certain embodiments, the filters 44 described above, including filters used in transmit and receive signal paths, may be low-pass filters, high-pass filters, or bandpass filters. A low-pass filter may pass signals below a selected cutoff frequency and attenuate signals above the selected cutoff frequency. A high-pass filter may pass signals above a selected cutoff frequency and attenuate signals below the selected cutoff frequency. A bandpass filter may pass signals within a selected pass-band and provide out-of-band rejection outside the selected pass-band.

In certain embodiments, the filters 44 described above may be waveguide filters, coupled-line filters, stepped-impedance filters, stub filters, lumped-element filters, or other frequency-selective filter structures. A waveguide filter may use a waveguide structure to pass selected frequencies and reject other frequencies. A coupled-line filter may use coupling between conductive lines to form a pass-band and an out-of-band response. A stepped-impedance filter may use transmission-line sections having different impedances. A stub filter may use one or more open-circuited or short-circuited stubs. A lumped-element filter may use lumped inductive, capacitive, or resistive elements. The selected filter structure may be chosen according to available layout area, desired frequency response, manufacturing constraints, or other design requirements.

In certain embodiments, the radiating element 20 may comprise a magneto-electric dipole antenna or a stacked patch antenna. A magneto-electric dipole antenna may include structures that provide electric-dipole radiation and magnetic-dipole radiation. A stacked patch antenna may include multiple patch structures arranged in a stacked relationship to radiate and receive electromagnetic signals.

In certain embodiments, the stacked patch antenna may have a rectangular shape, a circular shape, a polygonal shape, or another selected shape. The selected shape may be chosen according to the frequency band, polarization, array layout, or packaging constraints of the antenna apparatus. In certain embodiments, the stacked patch antenna may be a probe-fed stacked patch antenna or an aperture-coupled stacked patch antenna. The selected feeding structure may couple energy to one or more patch structures of the stacked patch antenna.

In certain embodiments, different ports 30 may be coupled to the radiating element 20 at different locations or through different feed structures. These different coupling arrangements may cause the radiating element 20 to radiate or receive signals having different polarizations. For example, a coupling arrangement may be selected for linear polarization, circular polarization, or another desired polarization.

In certain embodiments, a terminal coupled to a transmit signal path may be designated as terminal TX, a terminal coupled to a receive signal path may be designated as terminal RX, and a terminal coupled to a termination load may be designated as terminal TL. The first frequency band and the second frequency band may be assigned to the transmit signal path and the receive signal path in either order. For example, the first frequency band may be used as a transmit band and the second frequency band may be used as a receive band. In another example, the first frequency band may be used as a receive band and the second frequency band may be used as a transmit band.

The filter and port arrangement described above provides transmit-receive isolation through a combination of spatial separation and frequency selection. Spatial separation between selected ports 30 may provide port-to-port isolation. Frequency selection by the filters 44 may reject energy in an undesired band. In a transmit-receive arrangement, port-to-port isolation, rejection of receive-band energy along a transmit signal path, and rejection of transmit-band energy along a receive signal path may work together to establish or improve isolation between the transmit signal path and the receive signal path.

The array arrangements described above provide circular polarization through rotational placement of antenna elements 70, sub-array tiles 80, or both. In some embodiments, antenna elements 70 are individually arranged in different rotational orientations. In some embodiments, sub-array tiles 80 are rotated as units with respect to adjacent sub-array tiles 80. In some embodiments, antenna elements 70 or sub-array tiles 80 are arranged in four distinct rotational orientations uniformly spaced by the rotation angle about axis Z. These rotational arrangements may cause a combined far-field radiation pattern of an antenna array to exhibit circular polarization over a predetermined frequency band.

The foregoing description of embodiments has been presented for purposes of illustration and does not limit the disclosure to the precise forms described. Modifications, substitutions, and variations may be made without departing from the scope of the disclosure.

Although embodiments have been described separately, features described with respect to one embodiment may be combined with features described with respect to another embodiment unless the context clearly indicates otherwise. For example, any of the antenna apparatus configurations described with reference to FIGS. 1, 2, and 3 may be used in any of the antenna array configurations described with reference to FIGS. 4-11.

The described arrangements may improve transmit-receive isolation through the combination of port-to-port isolation and frequency selection, and may provide circular polarization through rotational placement of antenna elements 70, sub-array tiles 80, or both.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. An antenna apparatus, comprising:
a radiating element configured to radiate and receive electromagnetic signals;
N ports coupled to the radiating element, where N is an integer greater than or equal to 2;
a first circuit comprising a first filter coupled between a first port of the N ports and a transmit signal path, the first circuit configured to pass signals in a first frequency band and to provide a first out-of-band rejection in a second frequency band; and
a second circuit comprising a second filter coupled between a second port of the N ports and a receive signal path, the second circuit configured to pass signals in the second frequency band and to provide a second out-of-band rejection in the first frequency band;
wherein the first frequency band and the second frequency band are non-overlapping, and the first port and the second port are spatially separated to provide a port-to-port isolation therebetween.

2. The antenna apparatus of claim 1, wherein each of the first filter and the second filter is a low-pass filter, a high-pass filter, or a bandpass filter.

3. The antenna apparatus of claim 1, wherein each of the first filter and the second filter is a waveguide filter, a coupled-line filter, a stepped-impedance filter, a stub filter, or a lumped-element filter.

4. The antenna apparatus of claim 1, wherein the first filter is implemented by a first duplexer, and the second filter is implemented by a second duplexer;
wherein a first terminal of the first duplexer is coupled to the first port, a second terminal of the first duplexer is coupled to the transmit signal path, and a third terminal of the first duplexer is coupled to a first termination load; and
wherein a first terminal of the second duplexer is coupled to the second port, a second terminal of the second duplexer is coupled to the receive signal path, and a third terminal of the second duplexer is coupled to a second termination load.

5. The antenna apparatus of claim 1, wherein the port-to-port isolation, the first out-of-band rejection, and the second out-of-band rejection together establish a transmit-receive isolation between the transmit signal path and the receive signal path.

6. The antenna apparatus of claim 1, further comprising a termination load connected to a third port of the N ports, the termination load configured to prevent reflected energy from returning to the first circuit or the second circuit.

7. The antenna apparatus of claim 1, further comprising a termination load connected to a third port of the N ports, the termination load configured to absorb energy received at the third port.

8. The antenna apparatus of claim 1, wherein the radiating element comprises a magneto-electric dipole antenna or a stacked patch antenna.

9. The antenna apparatus of claim 8, wherein the stacked patch antenna has a rectangular shape, a circular shape, or a polygonal shape.

10. The antenna apparatus of claim 8, wherein the stacked patch antenna is a probe-fed stacked patch antenna or an aperture-coupled stacked patch antenna.

11. An antenna array, comprising:
a plurality of antenna elements, each antenna element comprising:
a radiating element configured to radiate and receive electromagnetic signals;
a plurality of ports coupled to the radiating element;
a first circuit comprising a first filter coupled between a first port of the plurality of ports and a transmit signal path, the first circuit configured to pass signals in a first frequency band and to provide a first out-of-band rejection in a second frequency band; and
a second circuit comprising a second filter coupled between a second port of the plurality of ports and a receive signal path, the second circuit configured to pass signals in the second frequency band and to provide a second out-of-band rejection in the first frequency band;
wherein the first frequency band and the second frequency band are non-overlapping, and the first port and the second port of each antenna element are spatially separated to provide a port-to-port isolation therebetween;
wherein the plurality of antenna elements are arranged in at least two distinct orientations differing from one another by a rotation angle about an axis normal to a plane of the antenna array; and
wherein a combined far-field radiation pattern of the antenna array exhibits circular polarization over a predetermined frequency band.

12. The antenna array of claim 11, wherein the rotation angle is equal to 360 degrees divided by M, where M is an integer greater than or equal to 2.

13. The antenna array of claim 12, wherein M is equal to 4 and the rotation angle is 90 degrees.

14. The antenna array of claim 12, wherein M is equal to 2 and the rotation angle is 180 degrees.

15. The antenna array of claim 11, wherein the plurality of antenna elements comprise antenna elements having a first orientation and antenna elements having a second orientation, the second orientation being rotated by the rotation angle with respect to the first orientation, and the antenna elements having the first orientation and the antenna elements having the second orientation are arranged in an alternating pattern.

16. The antenna array of claim 11, wherein a group of at least two adjacent ones of the plurality of antenna elements forms a sub-array tile, and the plurality of antenna elements are arranged such that the sub-array tile is rotated as a unit by the rotation angle with respect to an adjacent sub-array tile.

17. The antenna array of claim 16, wherein the sub-array tile comprises a 2x2 arrangement of the antenna elements.

18. The antenna array of claim 11, wherein each of the plurality of antenna elements is individually rotated by the rotation angle with respect to at least one adjacent antenna element of the plurality of antenna elements.

19. The antenna array of claim 11, wherein the plurality of antenna elements are arranged in four distinct orientations that are uniformly spaced by the rotation angle about the axis.
